(19) United States
(12) Patent Application Publication
(10) Pub. No.: US 2017/0078014 A1
(43) Pub. Date: Mar. 16, 2017

(54) BANDWIDTH EFFICIENT COOPERATIVE TWO-WAY AMPLIFY-AND- FORWARD RELAYING METHOD

(71) Applicant: KING FAHD UNIVERSITY OF PETROLEUM AND MINERALS, Dhahran (SA)

(72) Inventors: AHMED HASSAN ABD EL-MALEK MAHMOUD, DHAHRAN (SA); SALAM ADEL ZUMMO, DHAHRAN (SA)

(21) Appl. No.: 14/855,217

(22) Filed: Sep. 15, 2015

(51) Int. Cl. H04B 7/14; H04W 72/04

(52) U.S. Cl. CPC H04B 7/14; H04W 72/0446; H04W 72/0473

(57) ABSTRACT

The bandwidth efficient cooperative two-way amplify-and-forward relaying method allows users in a secondary network to utilize a relay node in the primary users' network while minimizing co-channel interference. In the method, two primary user network sources communicate through a primary user network relay node. A secondary user network source and a secondary user destination agree to act as relays for the primary network sources, all of the above using amplify-and-forward protocol. In return, the primary network relay node allows the secondary user source to communicate through the primary network relay node with the secondary user destination using decode-and-forward protocol. Five symbols, including four primary user symbols and one secondary user symbol, are transmitted in four time slots for a bandwidth efficiency of 1.25. The primary network relay and the secondary users relay transmissions have their power allocated to minimize symbol error rate and maximize sum rate.

### BACKGROUND OF THE INVENTION

1. Field of the Invention

The present invention relates to communication methods for networks utilizing relay nodes, and particularly to a bandwidth efficient cooperative two-way amplify-and-forward relaying method that allows users in a secondary network to utilize a relay node in the primary users' network while minimizing co-channel interference.

2. Description of the Related Art

Bi-directional relay communications are considered as a promising transmission scheme to increase network throughput and to improve spectral efficiency, especially with half-duplex communication models. The operations in bi-directional relaying communications can be divided into two phases, namely, a transmission phase, in which the two sources transmit their data, and a relaying phase, in which the relay node relays the previously received data.

The two well-known relaying protocols, namely, amplify-and-forward (AF) and decode-and-forward (DF), are typically employed, resulting in two categories of bi-directional communications known as two-phase and three-phase two-way relaying schemes. In the two phase scheme, the AF relaying protocol is applied, where two symbols are transmitted in two phases (one transmission and one relaying), while the DF relaying protocol is applied in a three-phase scheme, where 2 symbols are transmitted in three phases (two transmission and one relaying). Although the two-phase scheme achieves a relatively better spectral efficiency than the three-phase scheme, the three-phase scheme outperforms the two-phase scheme.

The performance of the two-way relaying schemes with various transmission protocols and network coding schemes has been investigated. However, none of the proposed amplify-and-forward relaying protocols have proven entirely satisfactory so that it has not been possible to take maximum advantage of the bandwidth efficiency of the amplify-and-forward relay protocol.

Thus, a bandwidth efficient cooperative two-way amplify-and-forward relaying solving the aforementioned problems is desired.

### SUMMARY OF THE INVENTION

The bandwidth efficient cooperative two-way amplify-and-forward relaying method allows users in a secondary network to utilize a relay node in the primary users' network while minimizing co-channel interference. In the method, two primary user network sources communicate through a primary user network relay node. A secondary user network source and a secondary user destination agree to act as relays for the primary network sources, all of the above using amplify-and-forward protocol. In return, the primary network relay node allows the secondary user source to communicate through the primary network relay node with the secondary user destination using decode-and-forward protocol. Five symbols, including four primary user symbols and one secondary user symbol, are transmitted in four time slots for a bandwidth efficiency of 1.25. The primary network relay and the secondary users relay transmissions have their power allocated to minimize symbol error rate and maximize sum rate.

These and other features of the present invention will become readily apparent upon further review of the following specification and drawings.

### BRIEF DESCRIPTION OF THE DRAWINGS

FIG. 1A is a block diagram showing the entity relations during the transmission phase in a first time slot in a bandwidth efficient cooperative two-way amplify-and-forward relaying method according to the present invention.

FIG. 1B is a block diagram showing the entity relations during the transmission phase in a second time slot in a bandwidth efficient cooperative two-way amplify-and-forward relaying method according to the present invention.

FIG. 2A is a block diagram showing the entity relations during the relaying phase in a third time slot in a bandwidth efficient cooperative two-way amplify-and-forward relaying method according to the present invention.

FIG. 2B is a block diagram showing the entity relations during the relaying phase in a fourth time slot in a bandwidth efficient cooperative two-way amplify-and-forward relaying method according to the present invention.

FIG. 3 is a plot comparing the bandwidth efficient cooperative two-way amplify-and-forward relaying method according to the present invention and conventional relaying schemes.

Similar reference characters denote corresponding features consistently throughout the attached drawings.

### DETAILED DESCRIPTION OF THE PREFERRED EMBODIMENTS

The bandwidth efficient cooperative two-way amplify-and-forward relaying has a primary user (PU) network that includes two PU sources that are communicating with each other via a single relay. On the other end, a secondary user (SU) source transmits its data to a SU destination via the same PU relay node. The PU network considers the SU network pairs (i.e., source and destination) as two additional relay nodes which help the original PU relay node in improving the PU network performance. As a reward for its cooperation, the PU network allows the SU network to communicate simultaneously via the PU relay node by applying decode-and-forward (DF) protocol. The proposed system transmits four PU symbols and one SU symbol in four time slots, which achieves a bandwidth efficiency of 1:25. Two power allocation optimization problems were formulated; one to minimize the average symbol error rate of both primary and secondary systems, while the other problem is to maximize the total achievable sum rate. A Lagrangian multiplier method is used to find the optimal solutions for both problems under the constraint of maximum allowable power budget.

The proposed relaying scheme considers multiuser joint detection at relay node and is based on a cooperative cognitive system between a PU network and a SU network. Further, there are several assumptions, such as that there is no direct link between sources and destinations, multiuser maximum likelihood detection, and that the SU pairs source and destination via the PU relay node. The SU network serves as relay nodes the PU network to mitigate its interference and improve system performance. A complete cooperative PU network consists of one PU source, one PU relay and one PU destination. The proposed work consider the SU network pairs (i.e., source and destination) as two extra relay nodes to improve PU network performance. Finally, the SU source communicates with its destination via the cooperation of the PU relay node following the well-known DF protocol while the PU network deals with SU transmission as an interference signal.

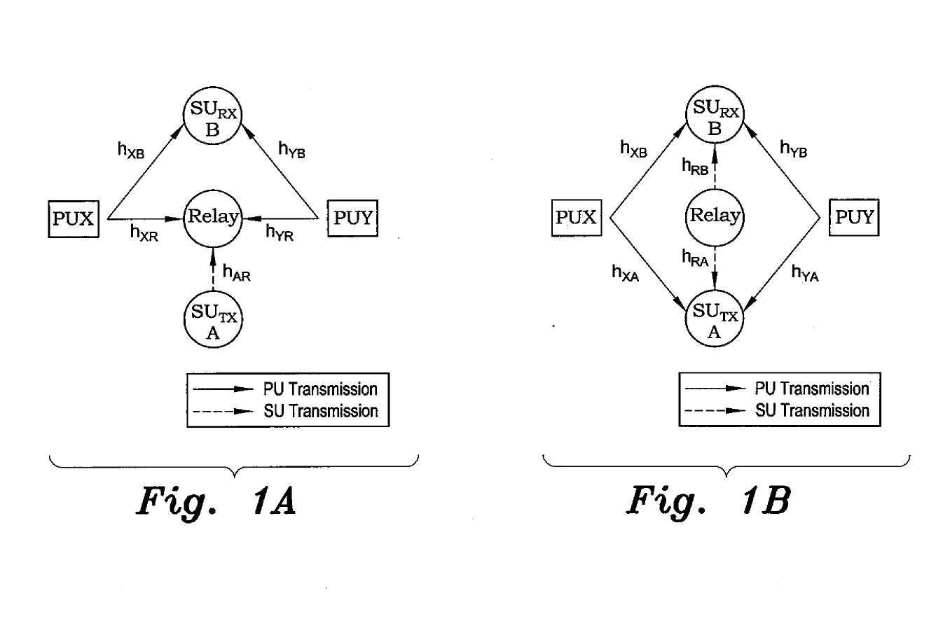

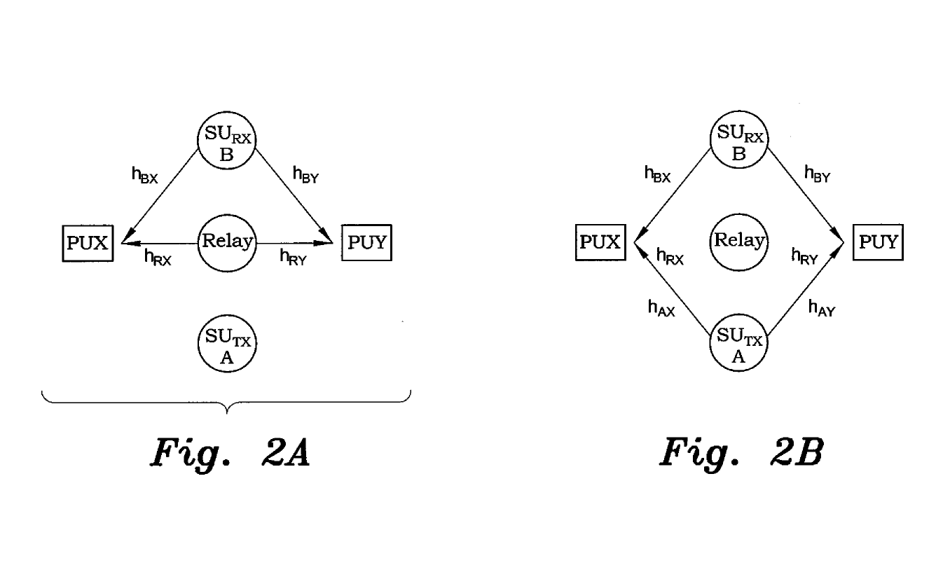

The operation of the proposed scheme that enables the transmission of four PU symbols and one SU symbol in four time slots is presented in FIGS. 1A, 1B, 2A, and 2B respectively. The channel gain between X and R is denoted by h_{XR}, and the channel gains between X and A and B are denoted by h_{XA} and h_{XB}, respectively, with an average of v_{X}². Similarly, the channel gains between Y and R, and A and B, are denoted by h_{YR}, h_{YA} and h_{YB}, respectively with an average of v_{Y}². The channel gain between A and R, are h_{AR} with average channel gain v_{A}². Finally, the channel gain between R and B is h_{RB} with an average of v_{R}².

For notational simplicity, all the channels are assumed to be independent and identically distributed (i.i.d) flat Rayleigh fading channels. For PU transmission, AF protocol is applied by the three relays since it is relatively less complex and relatively more flexible in handling interference than DF protocol. The operation of the proposed scheme can be divided into two phases. Namely, the transmission phase and the relaying phase.

In the first time slot shown in FIG. 1A, the PU sources X and Y transmit their modulated symbols denoted by x₁ and y₁ with transmission powers of P_{X} and P_{Y}, respectively. At the same time, SU source A transmits its data a₁ with power P_{A} which interferes with PU data at R. Since there is no direct link between the SU network pairs A and B, the SU receiver B receives the PU transmission with no interference. Then, the received signals at R and B during the first time slot are given by:

z_{R}⁽¹⁾=\sqrt{P_{X}}h_{XR}x₁+\sqrt{P_{Y}}h_{YR}y₁+\sqrt{P_{A}}h_{AR}a₁+w_{R}⁽¹⁾ (1)

z_{B}⁽¹⁾=\sqrt{P_{X}}h_{XB}x₁+\sqrt{P_{Y}}h_{YB}y₁+w_{B}⁽¹⁾, (2)

where w_{R} and w_{B} are AWGN samples with zero-mean and variance σ².

In the second time slot shown in FIG. 1B, PU sources X and Y transmit their second PU symbols x₂ and y₂ with transmission powers of PX and PY, respectively to A and B. Simultaneously, the relay R jointly decodes the previous received SU data symbol â₁ and transmits it to the SU receiver B with a transmission power P_{R}. The received signals at A and B during the second time slot are given by:

z_{A}⁽²⁾=\sqrt{P_{X}}h_{XA}x₂+\sqrt{P_{Y}}h_{YA}y₂+\sqrt{P_{R}}h_{RA}â₁+w_{A}⁽²⁾ (3)

z_{B}⁽²⁾=\sqrt{P_{X}}h_{XB}x₂+\sqrt{P_{Y}}h_{YB}y₂+\sqrt{P_{R}}h_{RB}â₁+w_{B}⁽²⁾, (4)

where w_{A} and w_{B} are AWGN samples with zero-mean and variance σ². By the end of transmission phase, the SU transmission is completed. The SU receiver B decodes the transmitted symbol â₁ from R, which is denoted by [symbol] ₁.

During the third time slot shown in FIG. 2A, PU and SU sources are idle while R transmits the received signal after trying to remove the interfered SU data a₁ by subtracting the decoded SU symbol at R (i.e., â₁) from the received signal z_{R}⁽¹⁾. On the other hand, the SU receiver B decodes the interfered SU data during the second time slot and applies AF protocol to the remaining signal. Under the assumption of knowing CSI by all relay nodes and destinations, the received signals at X and Y during the third time slot are given by:

z_{X}⁽³⁾=h_{RX}β_{R}(z_{R}⁽¹⁾−\sqrt{P_{A}}h_{AR}â₁)+h_{BX}β_{B}_{₂}(z_{B}⁽²⁾−\sqrt{P_{R}}h_{RB} [symbol] ₁.)+w_{X}⁽³⁾ (5)

z_{Y}⁽³⁾=h_{RY}β_{R}(z_{R}⁽¹⁾−\sqrt{P_{A}}h_{AR}â₁)+h_{BY}β_{B}_{₂}(z_{B}⁽²⁾−\sqrt{P_{R}}h_{RB} [symbol] ₁.)+w_{Y}⁽³⁾, (6)

where w_{X} and w_{Y} are AWGN samples with zero-mean and variance σ². The normalized amplification coefficient at R is given by

$${β}_{R}^{2} = \frac{{λ}_{R}}{{z}_{R}^{( 1 )}} .$$

### Similarly,

$${β}_{{B}_{2}}^{2} = \frac{{λ}_{{B}_{2}}}{{z}_{B}^{( 2 )}} .$$

During the fourth time slot shown in FIG. 2B, PU sources and relay nodes are idle while the SU nodes A and B relay the previously received PU data. The SU source A performs self-interference cancellation for its own data a₁ from its received signal during second time slot, i.e., Z_{A}⁽²⁾, then applies AF protocol to the resultant signal before re-transmitting it to both PU destinations X and Y. On the other hand, the SU destination B applies AF protocol to the previously received signal during first time slot, i.e., Z_{B}⁽²⁾, before re-transmitting to both PU destinations X and Y. The received signals at both PU destinations X and Y during the fourth time slot are given by:

z_{X}⁽⁴⁾=h_{BX}β_{B}_{₁}z_{B}⁽¹⁾+h_{AX}β_{A}(z_{A}⁽²⁾−\sqrt{P_{R}}h_{RA}a₁)+w_{X}⁽⁴⁾ (7)

z_{Y}⁽⁴⁾=h_{BY}β_{B}_{₁}z_{B}⁽¹⁾+h_{AY}β_{A}(z_{A}⁽²⁾−\sqrt{P_{R}}h_{RA}a₁+w_{Y}⁽⁴⁾, (8)

where w_{X} and w_{Y} are AWGN samples with zero-mean and variance σ². The normalized amplification coefficient at A is given by

$${β}_{A}^{2} = \frac{{λ}_{A}}{{z}_{A}^{( 2 )}} .$$

### Similarly,

$${β}_{{B}_{1}}^{2} = \frac{{λ}_{{B}_{1}}}{{z}_{B}^{( 1 )}} .$$

After the completion of the proposed system phases, the PU nodes apply self-interference cancellation on their received signals to remove their own data before the decoding process. Then, the received signals at both X and Y during the third time slot after self-interference cancellation are given by:

\tilde{z}_{X}⁽³⁾=z_{X}⁽³⁾−\sqrt{P_{X}}h_{XR}x₁−\sqrt{P_{X}}h_{XB}x₂ (9)

\tilde{z}_{Y}⁽³⁾=z_{Y}⁽³⁾−\sqrt{P_{Y}}h_{YR}y₁−\sqrt{P_{Y}}h_{YB}y₂. (10)

Similarly, the received signals at both X and Y during the fourth time slot after self-interference cancellation are given by:

\tilde{z}_{X}⁽⁴⁾=z_{X}⁽⁴⁾−\sqrt{P_{X}}h_{XB}x₁−\sqrt{P_{X}}h_{XA}x₂ (11)

\tilde{z}_{Y}⁽⁴⁾=z_{Y}⁽⁴⁾−\sqrt{P_{Y}}h_{YB}y₁−\sqrt{P_{Y}}h_{YA}y₂. (12)

From the previous equations and the presence of two PU destinations in this model, the matrix model for the proposed system at PU node X can be written as:

\tilde{z}_{X}=H_{X}y+\tilde{w}_{X}, (13)

where \tilde{z}_{X}=[\tilde{z}_{X}⁽³⁾ \tilde{z}_{X}⁽⁴⁾]^{T}, y=[y₁ y₂]^{T}, the channel matrix H_{X} is given by:

$${H}_{X} = [ \begin{matrix}{β}_{R} {h}_{RX} {h}_{RY} & {β}_{{B}_{2}} {h}_{BX} {h}_{YB} \\ {β}_{{B}_{1}} {h}_{BX} {h}_{YB} & {β}_{A} {h}_{AX} {h}_{YA}\end{matrix} ] , \qquad ( 14 )$$

and the noise vector at X is given by:

$${\tilde{w}}_{X} = [ \begin{matrix}{β}_{R} {h}_{RX} ( \sqrt{{P}_{A}} {h}_{AR} ( {a}_{1} - {\hat{a}}_{1} ) + {w}_{R}^{( 1 )} ) + \\ {β}_{{B}_{2}} {h}_{BX} ( \sqrt{{P}_{R}} {h}_{RB} ( {\hat{a}}_{1} - {\hat{\hat{a}}}_{1} ) + {w}_{B}^{( 2 )} ) + {w}_{X}^{( 3 )} \\ {β}_{{B}_{1}} {h}_{BX} {w}_{B}^{( 1 )} + {β}_{A} {h}_{AX} ( \sqrt{{P}_{R}} {h}_{RA} ( {\hat{a}}_{1} - {a}_{1} ) + {w}_{A}^{( 2 )} ) + {w}_{X}^{( 4 )}\end{matrix} ] . \qquad ( 15 )$$

Similarly, the matrix model for the proposed system at PU node Y can be written as:

\tilde{z}_{Y}=H_{Y}x+\tilde{w}_{Y}, (16)

where \tilde{z}_{Y}=[\tilde{z}_{Y}⁽³⁾ \tilde{z}_{Y}⁽⁴⁾]^{T}, y=[x₁ x₂]^{T}, the channel matrix H_{Y} is given by:

$${H}_{Y} = [ \begin{matrix}{β}_{R} {h}_{RY} {h}_{XR} & {β}_{{B}_{2}} {h}_{BY} {h}_{XB} \\ {β}_{{B}_{1}} {h}_{BY} {h}_{XB} & {β}_{A} {h}_{AY} {h}_{XA}\end{matrix} ] , \qquad ( 17 )$$

and the noise vector at Y is given by:

$${\tilde{w}}_{Y} = [ \begin{matrix}{β}_{R} {h}_{RY} ( \sqrt{{P}_{A}} {h}_{AR} ( {a}_{1} - {\hat{a}}_{1} ) + {w}_{R}^{( 1 )} ) + \\ {β}_{{B}_{2}} {h}_{BY} ( \sqrt{{P}_{R}} {h}_{RB} ( {\hat{a}}_{1} - {\hat{\hat{a}}}_{1} ) + {w}_{B}^{( 2 )} ) + {w}_{Y}^{( 3 )} \\ {β}_{{B}_{1}} {h}_{BY} {w}_{B}^{( 1 )} + {β}_{A} {h}_{AY} ( \sqrt{{P}_{R}} {h}_{RA} ( {\hat{a}}_{1} - {a}_{1} ) + {w}_{A}^{( 2 )} ) + {w}_{Y}^{( 4 )}\end{matrix} ] . \qquad ( 18 )$$

Note that, for a relay selection scheme, the best relay is selected with maximum channel gains for both PU sources (i.e., X and Y). Then, all the previous equations in relaying phase are valid with setting the unselected relay channel coefficients to zero.

A power allocation optimization problem was formulated to minimize the sum SER of both PU and SU networks of the proposed system by controlling the SU transmission power (i.e., P_{A} and P_{R}) and the three relays amplifying factors (i.e., λ_{A}, λ_{R}, λ_{B}_{₁}, and λ_{B}_{₂}). The goal is to find the values of those parameters that minimize the overall SER. Then, an optimization problem has been formulated in which the target function can be minimizing the total sum SER of the PU and SU networks. Such that:

$$\begin{matrix}minimize {SER}_{PU} + {SER}_{SU} \\ subject to {\sum }_{i} {P}_{i} + {\sum }_{j} {λ}_{j} \leq {\overline{P}}_{total} ,\end{matrix} \qquad ( 19 )$$

where i=A and R, while j=A, R, B1 and B2. Lagrangian multipliers method with the power constraint in (19) is used. The Lagrangian function ∫(.) can be expressed as:

∫(Pᵢ,λᵢ)=SER_{PU}+SER_{SU}+Λ₁(ΣᵢPᵢ+Σⱼλⱼ−P̅ₜₒₜₐₗ) (20)

where Λ₁ denotes the Lagrangian multipliers.

A power allocation optimization problem for maximizing the average achievable sum rate of the proposed system was also formulated. The average achievable sum rate is a function of SU transmission power (i.e., P_{A} and P_{R}) and the three relays amplifying factors (i.e., λA, λR, λ_{B}_{₁}, and λ_{B}_{₂}). The goal is to find the optimal values which maximize the average achievable sum rate. Then, an optimization problem has been formulated such that:

$$\begin{matrix}maximize {PU}_{} + {SU}_{} \\ subject to {\sum }_{i} {P}_{i} + {\sum }_{j} {λ}_{j} \leq {\overline{P}}_{total} .\end{matrix} \qquad ( 21 )$$

Following the same steps in solving equation (19), the optimal solution for rate maximization can be obtained.

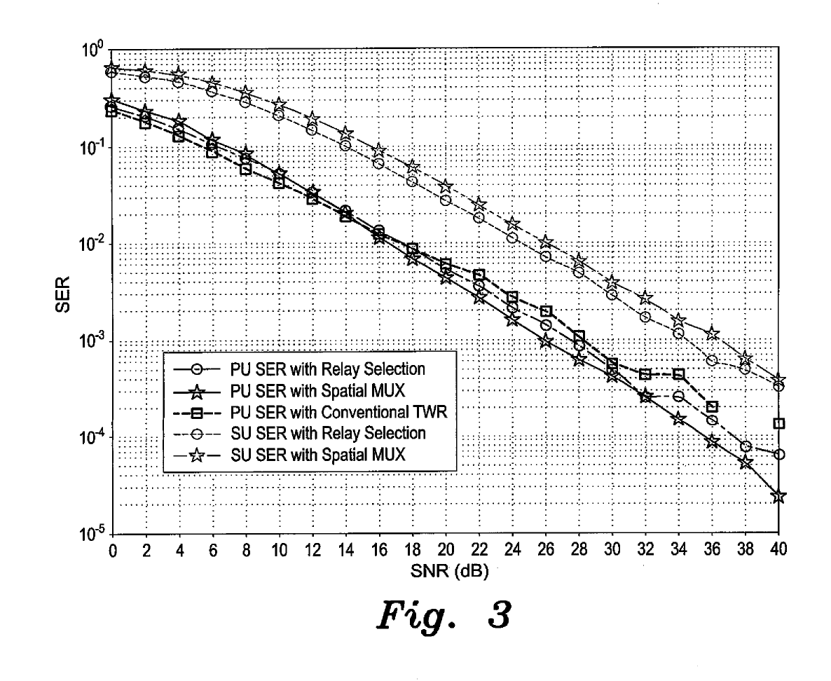

Referring to FIG. 3, numerical examples are presented to verify the performance of proposed scheme. Since the proposed scheme transmits 5 data symbols in 4 time slots with bandwidth efficiency equal to 1:25. The proposed system performance was compared with the conventional two-way AF relaying scheme. For a fair comparison, the total power budget is set to be the same. A SER performance comparison between the proposed system and the conventional TWR is presented in FIG. 3. Results show that the conventional TWR model achieves better SER performance compared to the proposed work. As the SNR goes higher, the proposed system in both cases of spatial multiplexing and relay selection outperforms the conventional TWR scheme, which encourages the PU system to cooperate with the SU network.

It is to be understood that the present invention is not limited to the embodiments described above, but encompasses any and all embodiments within the scope of the following claims.

We claim:

1. A bandwidth efficient cooperative two-way amplify-and-forward relaying method, comprising the steps of:
transmitting PU data from a primary user (PU) transmitter S to a primary user (PU) receiver D in cooperation with a first secondary user (SU) relay R_{A} (SU transmitter) and a second secondary user relay R_{B} (SU receiver), the PU data transmission being divided into first, second, third, and fourth time slots;
in the first time slot, both PU sources X and Y transmitting their first data symbols, x₁ and y₁, with transmission powers P_{X} and P_{Y}, respectively;
in the first time slot, SU source A transmitting its data symbol a₁ with power P_{A}, which interferes with PU data at the relay node R, while the SU receiver B receives the PU transmission with no interference under the assumption of no direct link between SU network pairs, the received signals at R and B during the first time slot being characterized by the relations:
z_{R}⁽¹⁾=\sqrt{P_{X}}h_{XR}x₁+\sqrt{P_{Y}}h_{YR}y₁+\sqrt{P_{A}}h_{AR}a₁+w_{R}⁽¹⁾
and
z_{B}⁽¹⁾=\sqrt{P_{X}}h_{XB}x₁+\sqrt{P_{Y}}h_{YB}y₁+w_{B}⁽¹⁾,
where w_{R} and w_{B} are AWGN samples with zero-mean and variance σ²;
in the second time slot, transmitting the second PU symbols x₂ and y₂ with transmission powers of P_{X} and P_{Y}, respectively, to A and B, and simultaneously transmitting the SU symbol previously decoded at the relay node R and denoted by â₁ to the SU receiver B with a transmission power P_{R}, so that the received signals at A and B during the second time slot are characterized by the relations:
z_{A}⁽²⁾=\sqrt{P_{X}}h_{XA}x₁+\sqrt{P_{Y}}h_{YA}y₂+\sqrt{P_{R}}h_{RA}â₁+w_{A}⁽²⁾
and
z_{B}⁽²⁾=\sqrt{P_{X}}h_{XB}x₂+\sqrt{P_{Y}}h_{YB}y₂+\sqrt{P_{R}}h_{RB}â₁+w_{B}⁽²⁾,
where w_{A} and w_{B} are AWGN samples with zero-mean and variance σ²;
in the third time slot, idling PU and SU sources while R transmits the received signal after trying to remove the interfered SU data a₁ by subtracting the decoded SU symbol at R from the received signal z_{R}⁽¹⁾, while the SU receiver B decodes the interfered SU data during the second time slot and applies AF protocol to the remaining signal, the received signals at X and Y during the third time slot being characterized by the relations:
z_{X}⁽³⁾=h_{RX}β_{R}(z_{R}⁽¹⁾−\sqrt{P_{A}}h_{AR}â₁)+h_{BX}β_{B}_{₂}(z_{B}⁽²⁾−\sqrt{P_{R}}h_{RB} [symbol] ₁.)+w_{X}⁽³⁾
and
z_{Y}⁽³⁾=h_{RY}β_{R}(z_{R}⁽¹⁾−\sqrt{P_{A}}h_{AR}â₁)+h_{BY}β_{B}_{₂}(z_{B}⁽²⁾−\sqrt{P_{R}}h_{RB} [symbol] ₁.)+w_{Y}⁽³⁾,
where w_{X} and w_{Y} are AWGN samples with zero-mean and variance σ², and the normalized amplification coefficient at R is given by
$${β}_{R}^{2} = \frac{{λ}_{R}}{{z}_{R}^{( 1 )}} and {β}_{{B}_{2}}^{2} = \frac{{λ}_{{B}_{2}}}{{z}_{B}^{( 2 )}} ;$$
in the fourth time slot, idling the PU sources and relay nodes while the SU nodes A and B relay the previously received PU data so that the SU source A performs self-interference cancellation for its own data a₁ from its received signal during the second time slot, then applying AF protocol to the resultant signal before re-transmitting it to both PU destinations X and Y, while the SU destination B applies AF protocol to the previously received signal during the first time slot before re-transmitting to both PU destinations X and Y, the received signals at both PU destinations X and Y during the fourth time slot being characterized by the relations:
z_{X}⁽⁴⁾=h_{BX}β_{B}_{₁}z_{B}⁽¹⁾+h_{AX}β_{A}(z_{A}⁽²⁾−\sqrt{P_{R}}h_{RA}a₁)+w_{X}⁽⁴⁾
and
z_{Y}⁽⁴⁾=h_{BY}β_{B}_{₁}z_{B}⁽¹⁾+h_{AY}β_{A}(z_{A}⁽²⁾−\sqrt{P_{R}}h_{RA}a₁)+w_{Y}⁽⁴⁾,
where w_{X} and w_{Y} are AWGN samples with zero-mean and variance σ², and the normalized amplification coefficient at A is given by
$${β}_{A}^{2} = \frac{{λ}_{A}}{{z}_{A}^{( 2 )}} and {β}_{{B}_{1}}^{2} = \frac{{λ}_{{B}_{1}}}{{z}_{B}^{( 1 )}} ;$$
applying self-interference cancellation at the PU nodes on their received signals to remove their own data before the decoding process, where the received signals at both X and Y during the third time slot after self-interference cancellation are characterized by the relations:
\tilde{z}_{X}⁽³⁾=z_{X}⁽³⁾−\sqrt{P_{X}}h_{XR}x₁−\sqrt{P_{X}}h_{XB}x₂
and
\tilde{z}_{Y}⁽³⁾=z_{Y}⁽³⁾−\sqrt{P_{Y}}h_{YR}y₁−\sqrt{P_{Y}}h_{YB}y₂,
and the received signals at both X and Y during the fourth time slot after self-interference cancellation are given by:
\tilde{z}_{X}⁽⁴⁾=z_{X}⁽⁴⁾−\sqrt{P_{X}}h_{XB}x₁−\sqrt{P_{X}}h_{XA}x₂
and
\tilde{z}_{Y}⁽⁴⁾=z_{Y}⁽⁴⁾−\sqrt{P_{Y}}h_{YB}y₁−\sqrt{P_{Y}}h_{YA}y₂;
allocating power to minimize the sum SER of both PU and SU networks by controlling the SU transmission power and the three relays amplifying factors given by λ_{A}, λ_{R}, λ_{B}_{₁}, and λ_{B}_{₂}, the target function minimizing the total sum SER of the PU and SU networks, the total sum being is characterized by:
$$\begin{matrix}minimize {SER}_{PU} + {SER}_{SU} , \\ subject to \text{:} {\sum }_{i} {P}_{i} + {\sum }_{j} {λ}_{j} \leq {\overline{P}}_{total}\end{matrix}$$
where i=A and R, while j=A, R, B1 and B2, and the Lagrangian function is expressed as:
$$( {P}_{i} , {λ}_{i} ) = {SER}_{PU} + {SER}_{SU} + {Λ}_{1} ( {\sum }_{i} {P}_{i} + {\sum }_{j} {λ}_{j} - {\overline{P}}_{total} )$$
where Λ₁ denotes the Lagrangian multipliers; and
allocating power to maximize the average achievable sum rate according to the relations:
$$\begin{matrix}maximize {PU}_{} + {SU}_{} \\ subject to {\sum }_{i} {P}_{i} + {\sum }_{j} {λ}_{j} \leq {\overline{P}}_{total} .\end{matrix}$$
